(19) United States
(12) Patent Application Publication
(10) Pub. No.: US 2007/0114707 A1
(43) Pub. Date: May 24, 2007

(54) Impact resistance vibration isolator

(76) Inventors: Shun-Hsu Tu, Taipei City (TW); Shao-Wei Chung, Chu Tung Jen (TW); Teng-Yuan Wu, Chang Hua City (TW); Ming-Fei Chen, Chang Hua City (TW); Wei-Lun Huang, Chang Hua City (TW); Lan-Qiao Zhan, Chang Hua City (TW)

Correspondence Address: RABIN & BERDO, P.C., Suite 500, 1101 14th Street, N.W., Washington, DC, 20005, US

(21) Appl. No.: 11/362,883

(22) Filed: Feb. 28, 2006

(30) Foreign Application Priority Data
Nov. 18, 2005 (TW) 94140691

(51) Int. Cl. F16F 3/00

(52) U.S. Cl. 267/161; 267/109; 267/148

(57) ABSTRACT

A wire rope vibration isolator is adapted to separate vibrations, mitigate impacts and reduce structural noises and includes a first fixed seat, a second fixed seat and a plurality of wire ropes. The wire ropes are separated from each other and respectively disposed between the first fixed seat and the second fixed seat. Moreover, the wire rope vibration isolator has a good damping effect in three-D directions to increase reliability and stability for precision machinery or products in working or moving processes, and the wire rope vibration isolator can reduce high-frequency noises. Hence, the wire rope vibration is safe and reliable, when it bears great impacts. Furthermore, the wire rope vibration isolator is easily assembled and used.

### BACKGROUND OF THE INVENTION

1. Field of The Invention

The present invention relates to an impact resistance vibration isolator, and particularly relates to a wire rope vibration isolator adapted for insulating vibration, cushioning impact and decreasing noise in industrial engineering fields.

2. Description of the Related Art

In many conditions, vibration is harmful to mechanical equipment—it effects working efficiency, decreases user life, brings noise and damages the structure of the mechanical equipment. In addition, it can contribute to serious accidents. Hence, vibration level must be decreased within an allowable safe range, so that damage is decreased.

In actual engineering, spiral spring vibration isolators are commonly used. Its damping element is composed of a spiral spring with grinded end sides. Moreover, the grinded end sides are vertical to an axial line of the spiral spring and are directly connected with a component for supporting the component. However, the spiral spring has gaps between spiral lines of the spiral spring. Hence, the spiral spring vibration isolator has a good cushioning capability, but its damping capability is bad.

The shortcomings of the spiral spring vibration isolator are as follows: 1. its cushioning capability is good, but damping capability is bad; 2. its loading is relative to Hooke's Law; 3. it can eliminate the loading in a direction horizontal to the axial line of the spiral spring, but another direction vertical to the axial line of the spiral spring can not be eliminated. Hence, the application of the spiral spring vibration isolator will be restricted.

### SUMMARY OF THE INVENTION

The present invention provides a wire rope vibration isolator. The wire rope vibration isolator has a good cushioning and impact-resistant capability, and reduces noise. Moreover, the wire rope vibration isolator has a good damping effect in three-D directions to increase reliability and stability for precision machinery or products in working or moving processes.

A first aspect of the present invention is a wire rope vibration isolator, comprising a first fixed seat, a second fixed seat and a plurality of wire ropes. The wire ropes are separated from each other and respectively disposed between the first fixed seat and the second fixed seat.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is an exposed view of a wire rope vibration isolator according to the first embodiment of the present invention; perspective

FIG. 2 is a perspective view of a wire rope vibration isolator according to the first embodiment of the present invention;

FIG. 3 is a front view of a wire rope vibration isolator according to the first embodiment of the present invention;

FIG. 4 is a lateral view of a wire rope vibration isolator according to the first embodiment of the present invention;

FIG. 5 is a lateral view of a wire rope according to the first embodiment of the present invention;

FIG. 6 is a perspective view of a wire rope vibration isolator according to the second embodiment of the present invention;

FIG. 7 is a perspective view of a wire rope vibration isolator according to the third embodiment of the present invention;

FIG. 8 is a perspective view of a wire rope vibration isolator according to the fourth embodiment of the present invention; and

FIG. 9 is a perspective view of a wire rope vibration isolator according to the fifth embodiment of the present invention.

### DETAILED DESCRIPTION OF PREFERRED BEST MOLDS

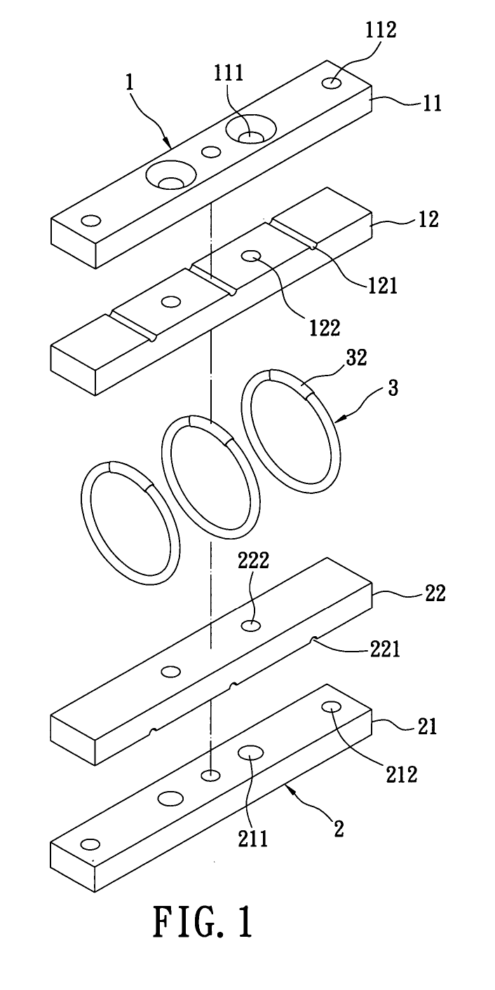

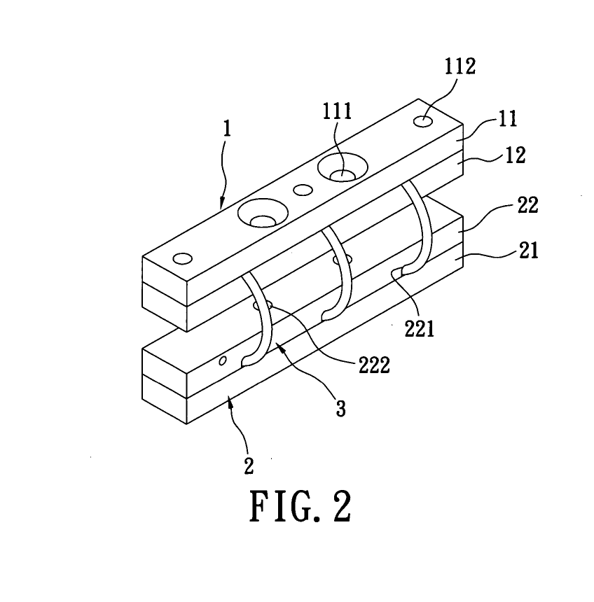

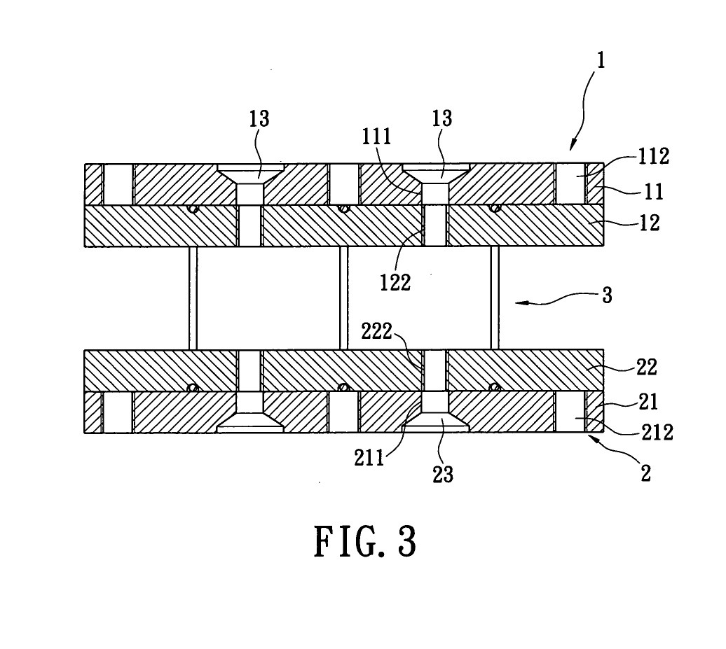

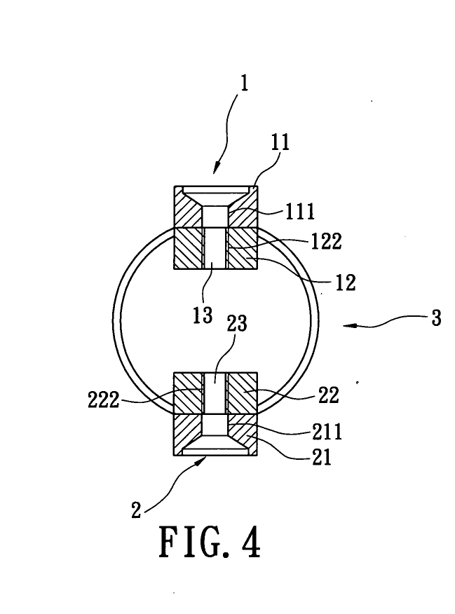

Referring to FIGS. 1 to 4, the first embodiment of the present invention provides a wire rope vibration isolator which comprises a first fixed seat 1, a second fixed seat 2 and a plurality of wire ropes 3 disposed between the first fixed seat 1 and the second fixed seat 2. The first fixed seat 1 comprises a first clip board 11 and a second clip board 12. Both the first clip board 11 and the second clip board 12 can be rectangular boards opposite to each other. However, the shape of the board is not limited. The second clip board 12 has a plurality of semi-circular grooves 121 that is formed on one surface thereof and faces the first clip board 11, and the wire ropes 3 are correspondingly received in the semi-circular grooves 121 for increasing contact areas between the first clip board 11 and the second clip board 12, and increase the compressive strength of the wire ropes 3.

The first clip board 11 and the second clip board 12 are connected together by connected elements 13. In the first embodiment, the connected elements 13 are screws, and the first clip board 11 and the second clip board 12 respectively have a first connected hole 111 and a second connected hole 122 corresponding to each other, and the connected elements 13 (the screws) can pass through the first connected hole 111 and the second connected hole 122 for the first clip board 11 and the second clip board 12 to connect with each other. The first clip board 11 further has a plurality of third connected holes 112 for connecting with a device or a base.

The second fixed seat 2 comprises a third clip board 21 and a fourth clip board 22. Both the third clip board 21 and the fourth clip board 22 can be rectangular boards opposite to each other. However, the shape of the board is not limited. The fourth clip board 22 has a plurality of semi-circular grooves 221 formed on one surface thereof and faces the third clip board 21. The wire ropes 3 are correspondingly received in the semi-circular grooves 221 for increasing contact areas between the third clip board 21 and the fourth clip board 22, and increasing the compressive strength of the wire ropes 3.

The third clip board 21 and the fourth clip board 22 are connected together by connected elements 23. In the first embodiment, the connected elements 23 are screws, and the third clip board 21 and the fourth clip board 22 respectively have a fourth connected hole 211 and a fifth connected hole 222 corresponding to each other. The connected elements 23 (the screws) can pass through the fourth connected hole 211 and the fifth connected hole 222 for the third clip board 21 and the fourth clip board 22 to connect with each other. The third clip board 21 further has a plurality of sixth connected holes 212 for connecting with a device or a base.

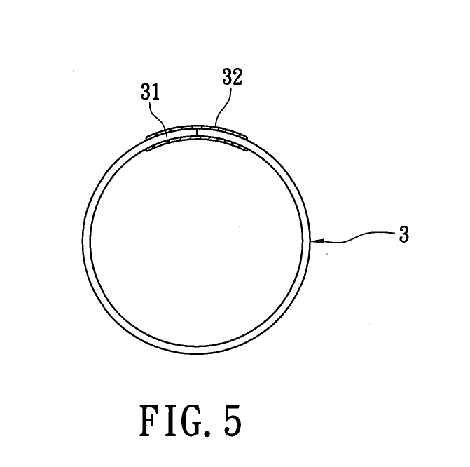

The wire ropes 3 are twisted by high intensity steel wires and are separated from each other. In the first embodiment, the wire ropes 3 are ring-shaped. Moreover, each of the wire ropes 3 has two end portions 31 retained together by a retained element 32 (such as FIG. 5), and the retained element 32 can increase the loading capability of the wire ropes 3. In addition, the retained element 32 is made of aluminum material that is not easily oxidized to avoid the retained element 32 from losing its clipping effect.

The wire ropes 3 are wound around between the first fixed seat 1 and the second fixed seat 2. In other words, each of the wire ropes 3 has a top edge and a bottom edge respectively clipped between two clip boards 11, 12 of the first fixed seat 1 and between two clip boards 21, 22 of the second fixed seat 2. The wire ropes 3 are received in the semi-circular grooves 121, 221. Moreover, the wire rope vibration isolator has a thin protection layer coated thereon. In other words, the protection layer is coated on the first fixed seat 1, the second fixed seat 2 and the wire ropes 3.

Furthermore, the wire ropes 3 can be vertically disposed between the first fixed seat 1 and the second fixed seat 2. In addition, the wire ropes 3 can be obliquely disposed between the first fixed seat 1 and the second fixed seat 2, or the wire ropes 3 can be left or right obliquely disposed between the first fixed seat 1 and the second fixed seat 2. However, the disposition of the wire ropes 3 should not be limited by the above-mentioned descriptions. Moreover, the wire ropes 3 can be separated from each other in the same interval. In other words, a interval between each two wire ropes 3 is the same. However, the wire ropes 3 can be separated from each other by different intervals. For example, some intervals between each two wire ropes 3 are larger and some intervals between each two wire ropes 3 are smaller. However, the interval between each two wire ropes 3 cannot be limited by the above-mentioned descriptions.

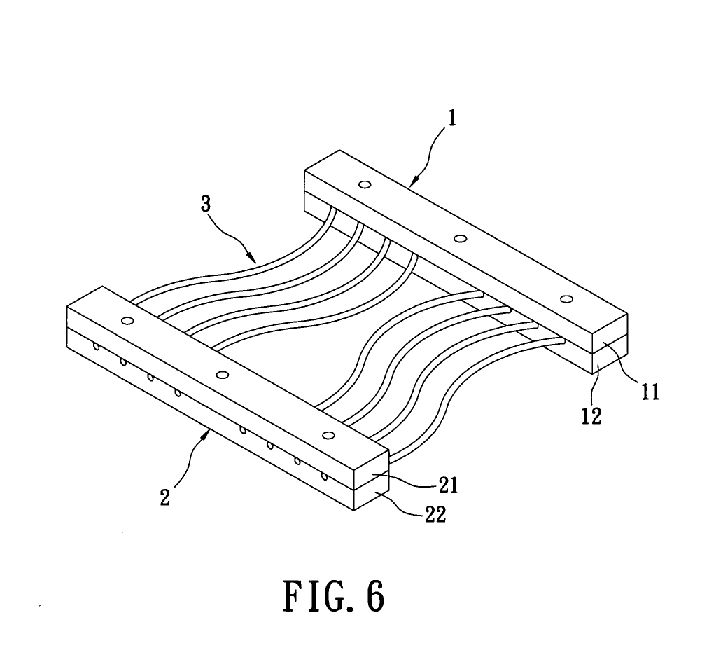

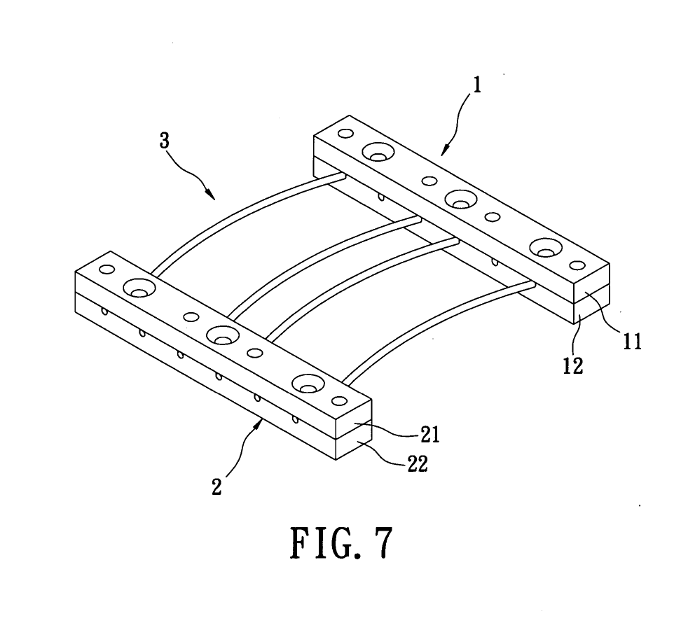

Referring to FIGS. 6 and 7, this embodiment discloses another wire rope vibration isolator that is not ring-shaped. The wire ropes 3 are strips and each of the wire ropes 3 is bent to form an arc-shape. Moreover, each of the wire ropes 3 has two end sides respectively fixed on between two clip boards 11, 12 of the first fixed seat 1 and between two clip boards 21, 22 of the second fixed seat 2.

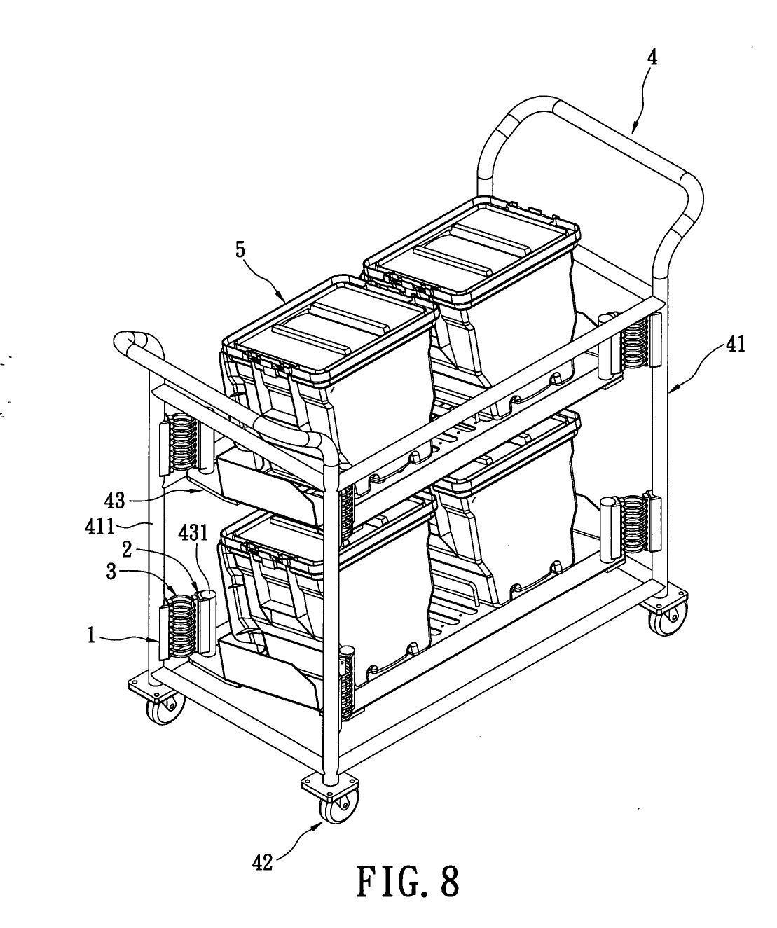

Referring to FIG. 8, the wire rope vibration isolators can adapt to a mobile support structure. The mobile support structure 4 comprises a support body 41, a plurality of wheels 42 connected to a base portion of the support body 41, at least one support platform 43 and a plurality of wire rope vibration isolators disposed between the support body 41 and the support platform 43. Hence, the support platform 43 is suspended on the support body 41 by the wire rope vibration isolators. In this embodiment, the wire rope vibration isolators are disposed on four corners of the support platform 43, and each of the wire rope vibration isolators has a first fixed seat 1 and a second fixed seat 2 respectively fixed on a vertical rod 411 of the support body 41 and a connected pole 431 of the support platform 43 by a screwing way or a welding way. Hence, the mobile support structure 4 can adapt to a wafer, an LCD panel or a precision instrument for protecting the wafer, the LCD panel or the precision instrument from strong vibrations. As can be seen in FIG. 8, wafer boxes 5 can be disposed on the support platform 43. Hence, when vibrations are transmitted from a ground direction, the wire rope vibration isolators can effectively absorb the vibrations. If vibrations occur from a horizontal direction, the wire rope vibration isolators can function as vibration insulation and have a cushioning effect.

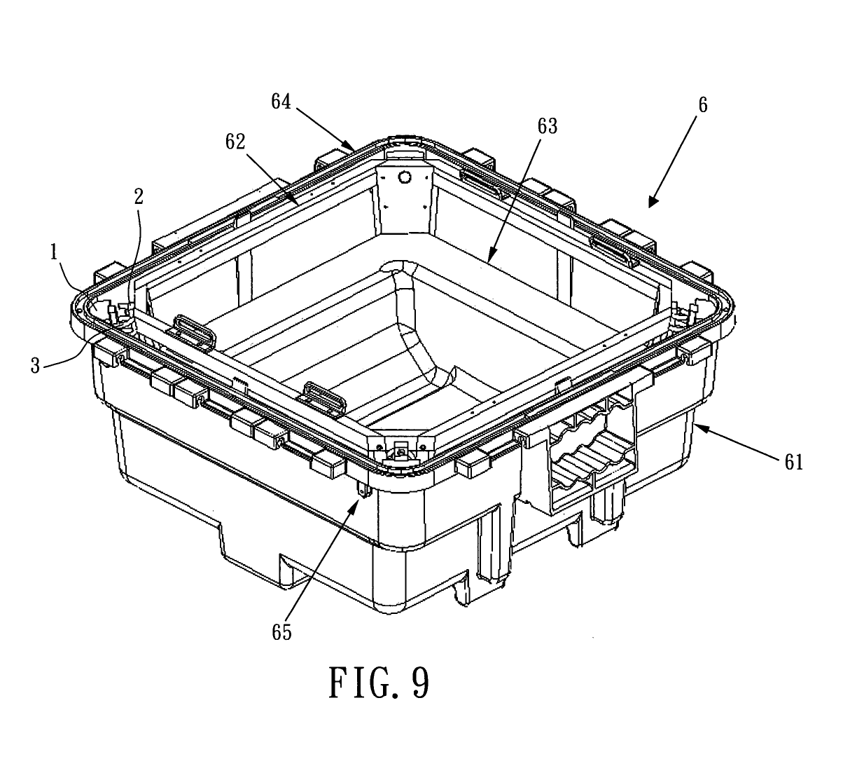

Referring to FIG. 9, the wire rope vibration isolators can adapt to a dual layer protection device for protection from vibrations. The protection device 6 comprises a box structure 61, an inner frame structure 62 disposed in the box structure 61, a plurality of wire rope vibration isolators disposed between the box structure 61 and the inner frame structure 62 and an inner structure 63 disposed in the inner frame structure 62. The box structure 61 is made of stiffened board and has an air silica gel washer 64 and an air valve device 65. The inner frame structure 62 is a stiffened frame structure and the inner structure 63 is a high polymer blowing material with antistatic function. Hence, the inner frame structure 62 is suspended in a box structure 61 by the wire rope vibration isolators. In this embodiment, the wire rope vibration isolators are disposed on four comers of the inner frame structure 62, and each of the wire rope vibration isolators is fixed between the box structure 61 and the inner frame structure 62 via screws or welding. Hence, the protection device 6 can adapt to a wafer, an LCD panel or a precision instrument for protecting the wafer, the LCD panel or the precision instrument from strong vibrations. Hence, when vibrations are transmitted from a ground direction, the wire rope vibration isolators can effectively absorb the vibrations. If vibrations occur from a horizontal direction, the wire rope vibration isolators can function as vibration insulation and have a cushioning effect.

In conclusion, the wire rope vibration isolator can be adapted for insulating vibration, cushioning impact and decreasing noise in different fields such as the air industry, the national defense industry, the transportation machine, the light industry and other industrial engineering fields.

Moreover, the wire rope vibration isolator has a good cushioning and impact-resistant capability, and reduces noise. Moreover, the wire rope vibration isolator has a good damping effect in three-D directions to increase reliability and stability for precision machinery or products in working or moving processes. Furthermore, the wire rope vibration isolator is easily assembled and used

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wire rope vibration isolator, comprising:
a first fixed seat;
a second fixed seat; and
a plurality of wire ropes separated from each other and respectively disposed between the first fixed seat and the second fixed seat.

2. The wire rope vibration isolator as claimed in claim 1, wherein the first fixed seat further comprises a first clip board and a second clip board, and each of the wire ropes is disposed between the first clip board and the second clip board; wherein the second clip board has a plurality of semi-circular grooves which is formed on one surface thereof and faces the first clip board, the wire ropes are correspondingly received in the semi-circular grooves, and the first clip board and the second clip board are connected together by connected elements.

3. The wire rope vibration isolator as claimed in claim 2, wherein connected element is a screw, the first clip board and the second clip board respectively have a first connected hole and a second connected hole corresponding to each other, and the screws pass through the first connected hole and the second connected hole.

4. The wire rope vibration isolator as claimed in claim 2, wherein the first clip board has a third connected hole for connecting with a device or a base.

5. The wire rope vibration isolator as claimed in claim 1, wherein the second fixed seat further comprises a third clip board and a fourth clip board, and each of the wire ropes is disposed between the third clip board and the fourth clip board; wherein the fourth clip board has a plurality of semi-circular grooves formed on one surface thereof and faces the third clip board, the wire ropes are correspondingly received in the semi-circular grooves, and the third clip board and the fourth clip board are connected together by connected elements.

6. The wire rope vibration isolator as claimed in claim 5, wherein connected element is a screw, the third clip board and the fourth clip board respectively have a fourth connected hole and a fifth connected hole corresponding to each other, and the screws pass through the fourth connected hole and the fifth connected hole.

7. The wire rope vibration isolator as claimed in claim 5, wherein the third clip board has a sixth connected hole for connecting with a device or a base.

8. The wire rope vibration isolator as claimed in claim 1, wherein the wire ropes are ring-shaped and are wound around between the first fixed seat and the second fixed seat.

9. The wire rope vibration isolator as claimed in claim 8, wherein each of the wire ropes has two end portions retained together by a retained element.

10. The wire rope vibration isolator as claimed in claim 9, wherein the retained element is made of aluminum material.

11. The wire rope vibration isolator as claimed in claim 1, wherein the wire ropes are vertically disposed between the first fixed seat and the second fixed seat.

12. The wire rope vibration isolator as claimed in claim 1, wherein the wire ropes are obliquely disposed between the first fixed seat and the second fixed seat.

13. The wire rope vibration isolator as claimed in claim 12, wherein the wire ropes are left or right obliquely disposed between the first fixed seat and the second fixed seat.

14. The wire rope vibration isolator as claimed in claim 1, wherein the wire ropes are strips, and each of the wire ropes has two end sides respectively fixed on the first fixed seat and the second fixed seat.

15. The wire rope vibration isolator as claimed in claim 1, wherein the wire ropes are high intensity ropes.

16. The wire rope vibration isolator as claimed in claim 1, wherein the wire ropes are separated from each other in the same interval.

17. The wire rope vibration isolator as claimed in claim 1, wherein the wire ropes are separated from each other by different intervals.

18. The wire rope vibration isolator as claimed in claim 1, wherein each of the wire ropes is bent to form an arc-shaped.

19. The wire rope vibration isolator as claimed in claim 1, further comprising a protection layer coated on the first fixed seat, the second fixed seat and the wire ropes.

20. A mobile support structure with wire rope vibration isolators, comprising:
a support body;
a plurality of wheels connected to a base portion of the support body;
at least one support platform; and
a plurality of wire rope vibration isolators, each having a first fixed seat, a second fixed seat and a plurality of wire ropes, wherein the wire ropes are separated from each other and are respectively disposed between the first fixed seat and the second fixed seat, and the first fixed seat and the second fixed seat are disposed between the support platform and the support body.

21. A dual layer protection device for preventing vibration, comprising:
a box structure;
an inner frame structure disposed in the box structure;
a plurality of wire rope vibration isolators, each having a first fixed seat, a second fixed seat and a plurality of wire ropes, wherein the wire ropes are separated from each other and are respectively disposed between the first fixed seat and the second fixed seat, and the first fixed seat and the second fixed seat are disposed between the box structure and the internal frame structure; and
an inner structure disposed in the inner frame structure.
